(19) United States
(12) Patent Application Publication
(10) Pub. No.: US 2006/0239349 A1
(43) Pub. Date: Oct. 26, 2006

(54) Image coding unit and image coding method

(75) Inventor: Tetsuya Shibayama, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/406,389

(22) Filed: Apr. 19, 2006

(30) Foreign Application Priority Data
Apr. 22, 2005 (JP) 2005-125558

(51) Int. Cl. H04N 7/12

(52) U.S. Cl. 375/240.12

(57) ABSTRACT

An image coding unit and an image coding method which assure high speed and high image quality with a simple structure. For coding plural sub macroblocks into which a macroblock to be coded is divided, plural types of virtual predicted image data are generated using target image data to be coded in a sub macroblock concerned and an adjacent sub macroblock, and intra-frame prediction mode decision information to select the most suitable virtual predicted image data of one type from among the plural types of virtual predicted image data is generated. According to this prediction mode decision information, real predicted image data is generated by intra-frame prediction operation using reference image data in the adjacent sub macroblock, and difference from the target image data is coded.

### CROSS-REFERENCE TO RELATED APPLICATION

The present application claims priority from Japanese patent application No. 2005-125558 filed on Apr. 22, 2005, the content of which is hereby incorporated by reference into this application.

### BACKGROUND OF THE INVENTION

The present invention relates to an image coding unit and an image coding method and more particularly to technology which is useful for an image coding unit and an image coding method which comply with H.264/MPEG4-AVC.

The H.264/MPEG4-AVC (Advanced Video Coding) standard (hereinafter called H.264), as defined by ITU-T and MPEG (Moving Picture Experts Group), provides a standard method of predicting an image within a frame and coding it for improvement in coding efficiency by generating predicted image data from peripheral pixel data of a block in an image to be coded and transmitting data on difference from the block to be coded. Intra-frame prediction is available in the following modes: the Intra 4×4 mode in which prediction is made for the luminance component on the basis of 4 by 4 pixels (called a sub macroblock), the Intra 16×16 mode in which prediction is made on the basis of 16 by 16 pixels (called a macroblock), and the Intra chroma mode in which prediction is made for the color difference component on the basis of 8 by 8 pixels. In addition, depending on the profile, there is a mode in which luminance component prediction is made on the basis of 8 by 8 pixels (called a block). Image coding techniques of this type are disclosed in Japanese Unexamined Patent Publication No. 2004-200991 and Japanese Unexamined Patent Publication No. 2005-005844.

### SUMMARY OF THE INVENTION

The conventional intra-frame prediction method is as follows: as shown in FIG. 9, from a target block 100 to be coded and reference image data, peripheral pixel data 101 of the target block is read; and in a predicted image data generation section 102, plural types of predicted image data according to various prediction modes are generated; and in an evaluation section 103, a prediction mode which provides the highest coding efficiency is determined from the difference between the predicted image data and the target image data to be coded. The process of predicted image data generation is explained next, taking the DC mode as one Intra 16×16 mode for example. As illustrated in FIG. 3, in the case of intra-frame prediction for macroblock X, if macroblocks A and C are both predictable, namely both macroblocks A and C have already been coded and there exists reference image data as a result of decoding them, the average of decoded 16-pixel data under macroblock C, located just above macroblock X, and 16-pixel data on the right of macroblock A, located on the left of macroblock X, represents a predicted image. Since there are no adjacent pixels in macroblocks at the left end or at the top of one frame screen, prescribed data are given for them.

In accordance with the H.264 standard, in order to decide the intra-frame prediction mode, the Intra 4×4 mode and the Intra 16×16 mode are compared and whichever provides the higher coding efficiency is chosen as the intra-frame prediction mode for luminance, where for the Intra 4×4 mode, a mode which is thought to be the highest in coding efficiency is selected from nine modes on the basis of sub macroblocks, and for the Intra 16×16 mode, a mode which is thought to be the highest in coding efficiency is selected from four modes on the basis of macroblocks. As for the color difference component, similarly a mode which is thought to be the highest in coding efficiency is selected from four modes on the basis of blocks.

In deciding the Intra 4×4 mode as mentioned above, it is necessary to process 16 sub macroblocks (0-15) in a macroblock as shown in FIG. 10 sequentially for each of nine prediction modes (0-8). More specifically for sub macroblock 0, nine types of predicted image data corresponding to modes 0 to mode 8 are generated in intra-frame prediction, and decoding steps including transformation, quantization, inverse quantization, inverse transformation and intra-frame compensation are carried out in the predicted image data generation section 102; and difference between the resulting data and target image data is calculated and optimum predicted image data is selected in the evaluation section 103 so that a coded signal is made from the data m used for selection among the above modes 0-8 and the above difference data d. Here, the target image data refers to original image data which is to be coded. A coded signal for the above optimum predicted image data in decoded form is stored in a memory as reference image data.

For example, in an arrangement of sub macroblocks as shown in FIG. 4, when sub macroblock 1 is to be processed, the result of the decoding process for sub macroblock 0, namely reference image data, is needed, which means that intra-frame prediction for sub macroblock 1 cannot be started immediately because, after completion of intra-frame prediction for sub macroblock 0, it is necessary to wait for generation of nine types of predicted image data as mentioned above, selection among them and completion of the decoding process. Therefore, for coding 16 sub macroblocks of a macroblock, it is necessary to generate nine types of predicted image data corresponding to modes 0 to 8 and carry out the steps of transformation, quantization, inverse quantization, inverse transformation and intra-frame compensation for each of 16 sub macroblocks 0 to 15. If nine signal processing circuits are provided in order to generate nine types of predicted image data corresponding to modes 0 to 8 as mentioned above, nine types of predicted image data can be generated simultaneously, so that signal processing is done at a relatively high speed. However, in this case, since circuitry which can perform parallel processing of nine types of signals for simultaneous generation of nine types of predicted image data is needed, a larger circuitry scale would be required and power consumption would increase. If some of the nine modes are omitted, the required circuitry scale could be smaller but optimization of predicted image data would be sacrificed, resulting in a poorer image quality on the receiving side.

An object of the present invention is to provide an image coding unit and an image coding method which assure high speed and high image quality with a simple structure. The above and further objects and novel features of the invention will more fully appear from the following detailed description in this specification and the accompanying drawings.

A most preferred embodiment of the present invention is briefly outlined as follows. For coding plural sub macroblocks into which a macroblock to be coded is divided, plural types of virtual predicted image data are generated using target image data in a sub macroblock concerned and an adjacent sub macroblock, and intra-frame prediction mode decision information to select the most suitable virtual predicted image data of one type from among the plural types of virtual predicted image data is generated. According to this prediction mode decision information, real predicted image data is generated by intra-frame prediction operation using reference image data in the adjacent sub macroblock and the difference from the target image data is coded.

Since prediction mode decision information is determined using target image data to be coded, an image coding unit and an image coding method which assure high speed and high image quality with a simple structure can be obtained.

### BRIEF DESCRIPTION OF THE DRAWINGS

The invention will be more particularly described with reference to the accompanying drawings, in which:

FIG. 1 is a block diagram showing an image coding method according to the present invention;

FIG. 2 is a block diagram explaining the image coding method as shown in FIG. 1;

FIG. 3 illustrates the DC mode as one Intra 16×16 mode for predicted image data generation;

FIG. 4 is a block diagram showing an arrangement of sub macroblocks for image coding according to the present invention;

FIG. 5 is a block diagram showing an image coding unit according to an embodiment of the present invention;

FIG. 6 is a block diagram showing details of an intra-frame prediction mode decision section according to an embodiment of the invention;

FIG. 7 is a block diagram showing details of an intra-frame prediction operation section according to an embodiment of the invention;

FIG. 8 is a block diagram showing a system LSI including an image coding unit according to an embodiment of the present invention;

FIG. 9 is a block diagram showing a conventional image coding method; and

FIG. 10 is a block diagram explaining the image coding method as shown in FIG. 9.

### DETAILED DESCRIPTION OF THE PREFERRED EMBODIMENTS

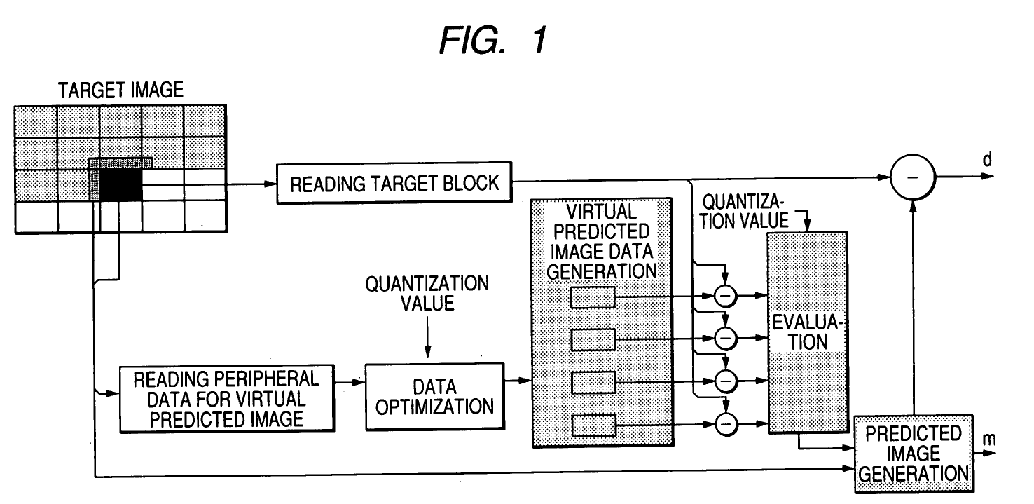

FIG. 1 is a block diagram showing an image coding method according to the present invention. The figure is intended to explain how coding in the Intra 4×4 mode is performed in accordance with the H.264 standard. In the figure, the target image to be coded corresponds to an image memory where target image data is expressed by white and reference image data as mentioned above is expressed by hatching. It should be understood that the target image data to be expressed by white is hidden in the hatched portion for reference image data. In other words, both the reference image data and the target image data exist in the hatched portion. The macroblock as the target of coding is expressed by black.

According to this embodiment, prior to coding in the Intra 4×4 mode, a peripheral data reading section for virtual prediction reads not reference image data but target image data supposed to be expressed by white and the image data expressed by black indicating the target macroblock. The read virtual prediction data is processed by a data optimization section by reference to a quantization value and virtual predicted image data is generated in a virtual predicted image data generation section. More specifically, nine types of virtual predicted image data corresponding to the abovementioned nine modes are generated and the difference between this and the target data obtained by the target macroblock reading section is calculated before optimum virtual predicted image data is selected in an evaluation section according to the difference. Based on the result of this evaluation, mode information which has been used for selection of virtual prediction data among nine modes 0 to 8 is extracted. Then, in a predicted image generation section, using the extracted mode information and not the above target image data but reference image data, real predicted image data is generated in the Intra 4×4 mode and the above difference data d, based on the target data, and the extracted mode information m are outputted as a coded signal.

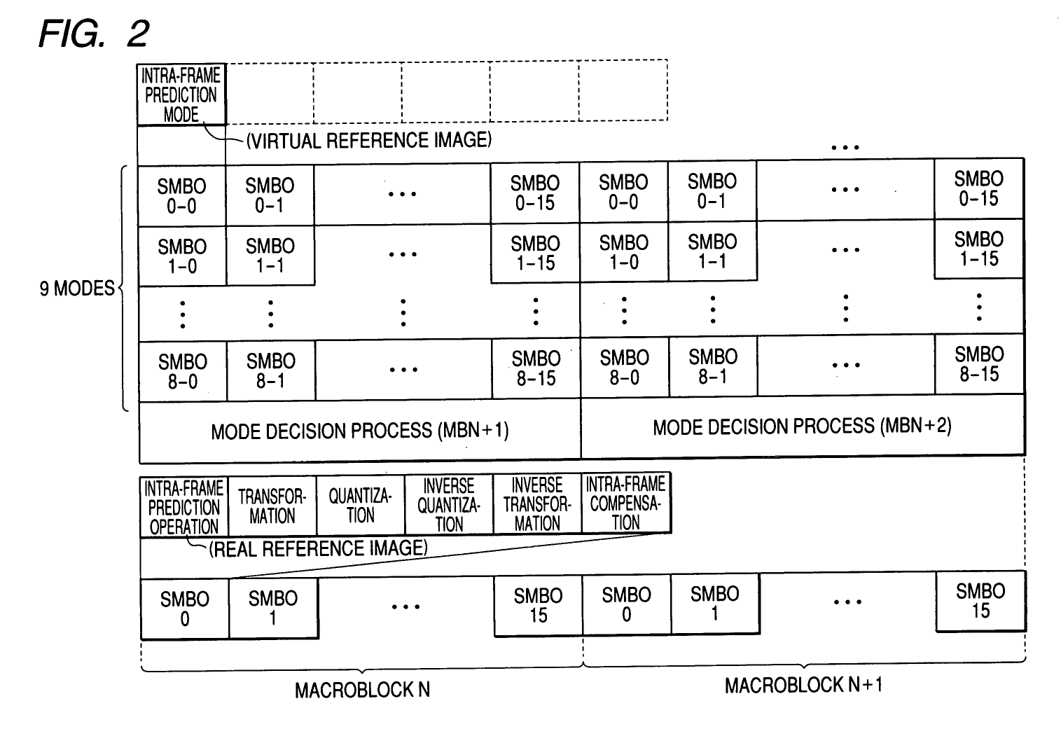

FIG. 2 is a block diagram explaining the image coding method as shown in FIG. 1. In this embodiment, data processing for coding in the above Intra 4×4 mode is divided into two steps. Specifically, mode selection operation for selecting optimum predicted image data and operation for generating predicted image data and reference image data can be performed separately in terms of time. One of the above two steps is considered to be a mode decision process and the other a process to generate predicted image data and reference image data.

The above mode decision process consists of, for one macroblock (MB), 9 by 16 sub macroblock operations, which include sub macroblock operations 0-0 to 0-15, sub macroblock operations 1-0 to 1-15 and so on up to sub macroblock operations 8-0 to 8-15 corresponding to the above nine modes. Each sub macroblock operation is made in an intra-frame prediction mode only. In this intra-frame prediction mode, target image data is used as virtual reference image data as described in reference to FIG. 1. All that is done in the intra-frame prediction mode is just to generate virtual predicted image data corresponding to nine modes 0 to 8 using target image data and extract mode information which generates a process of selecting optimum predicted image data among the data. Therefore, though sub macroblock operations must be made 9 by 16 times as mentioned above, the time required for the mode decision process is relatively short and there is no need to wait for completion of operations for adjacent sub macroblocks, permitting high speed processing.

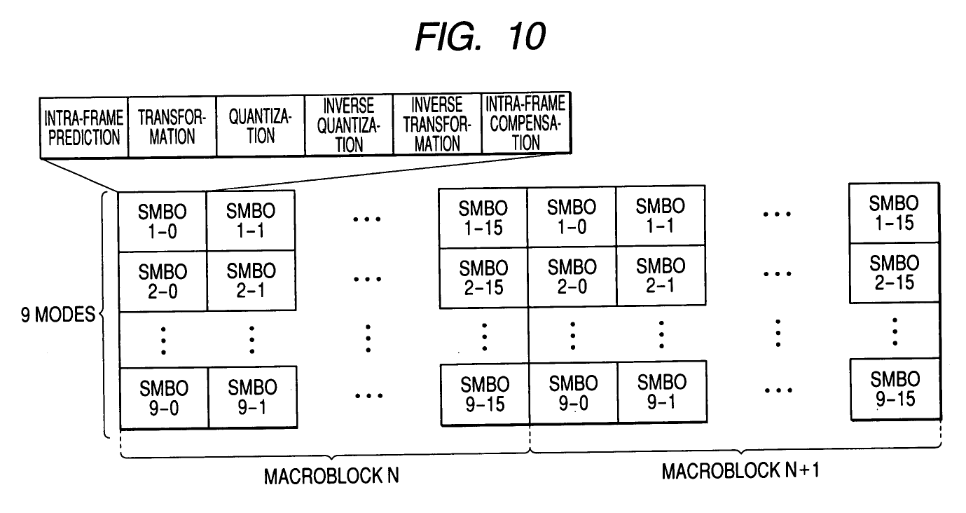

On the other hand, the process of generating predicted image data and reference data includes the steps of intra-frame prediction operation, transformation, quantization, inverse quantization, inverse transformation and intra-frame compensation and requires processing of large volumes of data; however, since the mode information extracted in the above mode decision process is used, this process need not be repeated for all the nine modes as in the case of FIG. 10 but only 16 sub macroblock operations 0 to 15 are needed for one macroblock (MB). In sub macroblock operations 0 to 15, real reference image data is used to generate predicted image data; for example, sub macroblock operation 0 can be started immediately because reference image data for another macroblock adjacent to it has been generated, and sub macroblock operation 1 can be started immediately using the reference image data generated by the sub macroblock operation 0. Subsequent sub macroblock operations up to 15 can be carried out in the same way.

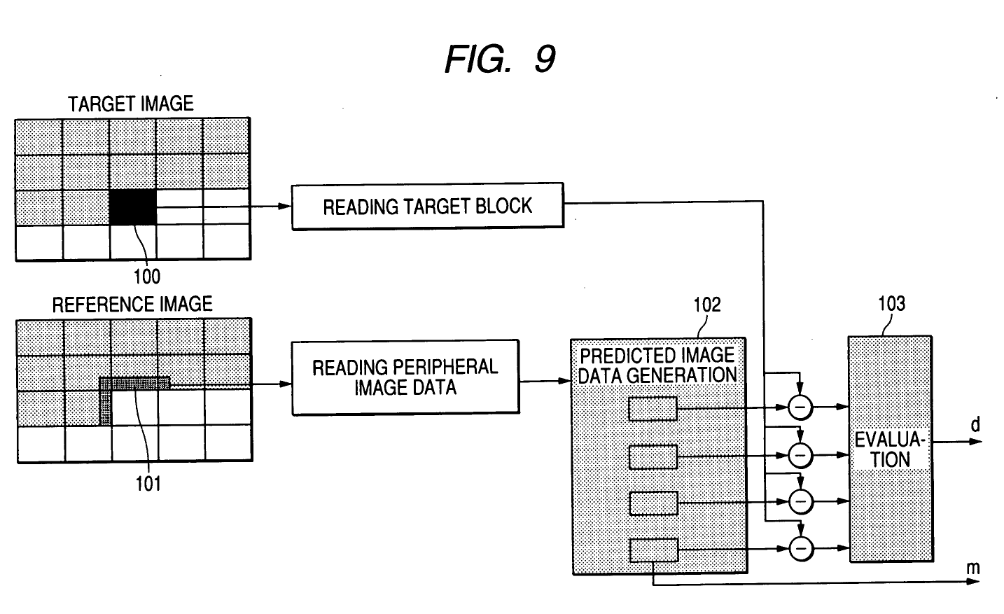

In this embodiment, since mode decision operation and operation for generating predicted image data and reference image data can be performed separately in terms of time, namely the above mode decision operation does not require reference image data and therefore the mode decision process for the macroblock to be coded next, or macroblock N+1, is carried out during generation of predicted image data and reference image data for macroblock N as mentioned above. In case that pipeline operation like this is adopted, when predicted image data and reference image data as mentioned above are to be generated, sub macroblock operations 0 to 15 can be immediately carried out in sequence because mode information required for intra-frame prediction operation in the above sub macroblock operations 0 to 15 has already been extracted in the preceding cycle. This feature of the present invention can be easily understood by comparison between FIGS. 1 and 9 and between FIGS. 2 and 10.

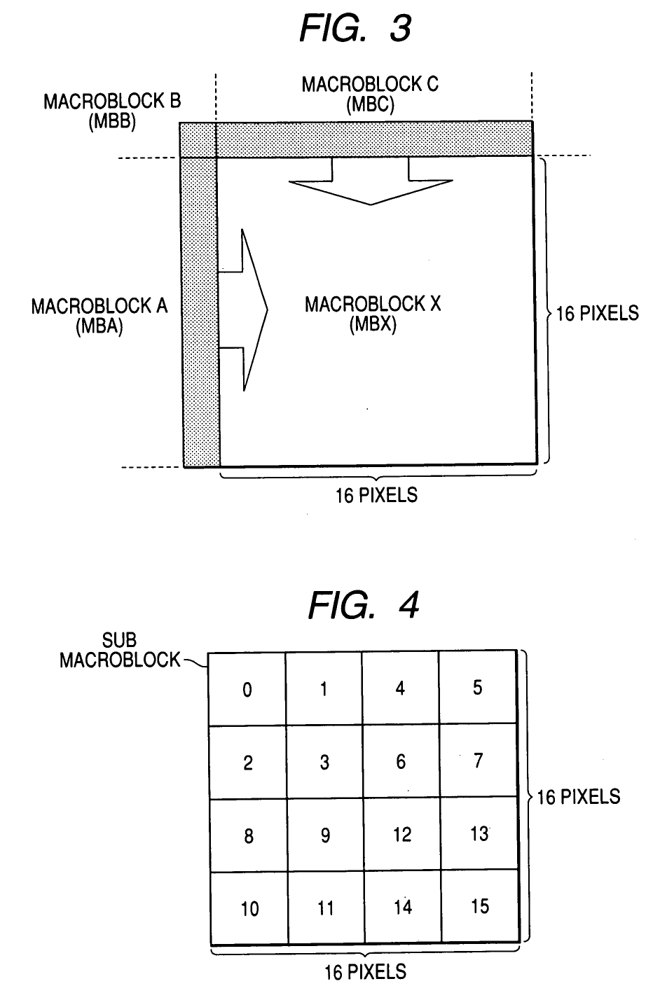

FIG. 3 illustrates the DC mode as one Intra 16×16 mode for predicted image data generation. When intra-frame prediction for macroblock X is to be made and macroblocks A and C are both predictable, the average of decoded 16-pixel data under macroblock C, located just above macroblock X, and 16-pixel data on the right of macroblock A, located on the left of macroblock X, represents a predicted image. Reference image data is used as peripheral pixel data for generation of a predicted image. In this Intra 16×16 mode, for coding the macroblock X, reference image data for generating relevant predicted image data is always available and it is unnecessary to apply the present invention.

FIG. 4, which has been used to explain the problem to be solved by the present invention, shows an arrangement of sub macroblocks for image coding according to the present invention. As shown in the figure, a macroblock consisting of 16 by 16 pixels is divided into 16 sub macroblocks each consisting of 4 by 4 pixels. When sub macroblock operations 0 to 15 as shown in FIG. 2 have been made for sub macroblocks 0 to 15 in the numerical order shown in the figure, it follows that real reference image data required for predicted image data always preexists.

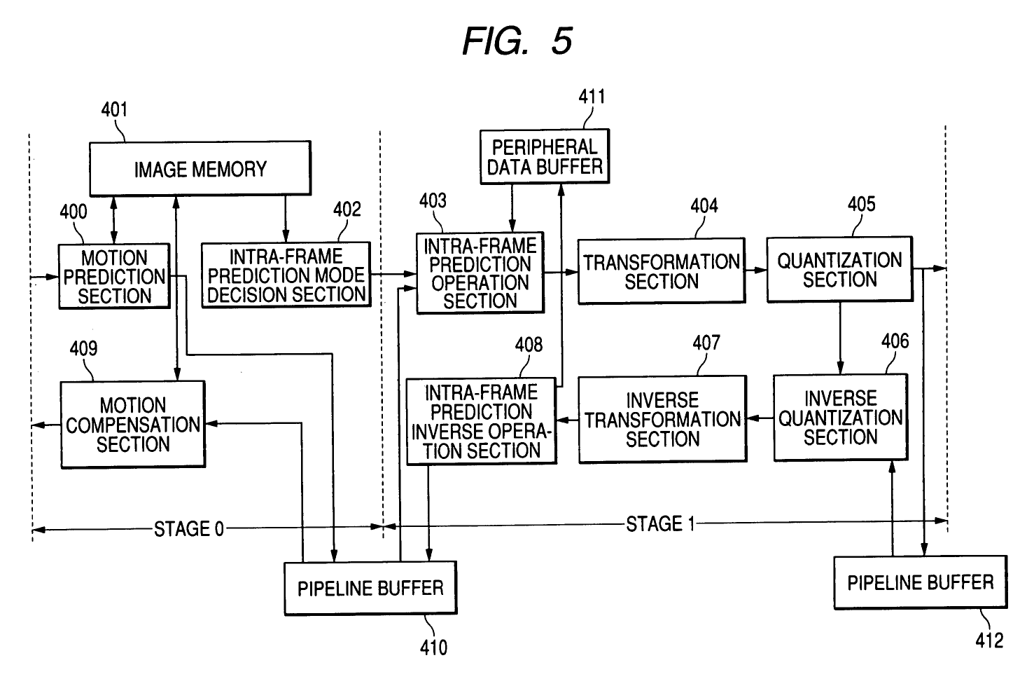

FIG. 5 is a block diagram showing an image coding unit according to an embodiment of the present invention. In this embodiment, an intra-frame prediction mode decision section 402 and an intra-frame prediction operation section 403 belong to different pipeline stages 0 and 1 respectively. Here, numeral 400 represents a motion prediction section; 401 an image memory; 404 a transformation section; 405 a quantization section; 406 an inverse quantization section; 407 an inverse transformation section; 408 an intra-frame prediction inverse operation section; 409 a motion compensation section; 410 a pipeline buffer; and 411 a peripheral data buffer.

Using the mode information previously extracted in the intra-frame prediction mode decision section, the intra-frame prediction operation section 403 acquires reference image data from the pipeline buffer 410 and generates predicted image data. Then, as shown in FIG. 2, transformation takes place in the transformation section 404; quantization takes place in the quantization section 405; inverse quantization takes place in the inverse quantization section 406; inverse transformation takes place in the inverse transformation section 407; and intra-frame prediction inverse operation section generates reference image data and stores it in the pipeline buffer 410. In pipeline stage 0, the intra-frame prediction mode decision section 402 extracts mode information on the basis of sub macroblocks (4 by 4 pixels) using the macroblock concerned and its peripheral image data which are stored in the image memory 401.

The motion prediction section 400 and motion compensation section 409 are used for inter-frame prediction (inter prediction). Although inter-frame prediction is not directly associated with the present invention, the general idea of motion prediction and motion compensation as the base for inter-frame prediction is explained next. Motion prediction refers to a process of detecting, from a coded picture (reference picture), its part similar in content to a target macroblock. A certain search area of a reference picture including the spatially same location as a particular luminance component of the present picture is specified and a search is made within this search area by vertical and horizontal pixel-by-pixel movements and the location where the evaluation value is minimum is taken as the predicted location for that block. For the calculation of the evaluation value, a function which includes motion vector bits in addition to the sum of absolute values or sum of squared errors of prediction error signals in the block is used. A motion vector is a vector which indicates the amount of movement from the original block to a search location. Motion compensation refers to generation of a predicted block from a motion vector and a reference picture.

In this embodiment, since the abovementioned target image data (present picture) and reference picture are stored in the image memory 401 used for inter-frame prediction as mentioned above, it is also used for intra-frame prediction as mentioned above. Specifically, an intra-frame prediction mode decision section is added and an intra-frame prediction operation section deals with one sub macroblock, so that an image coding unit and an image coding method which assure high speed and high image quality with a simple structure can be realized.

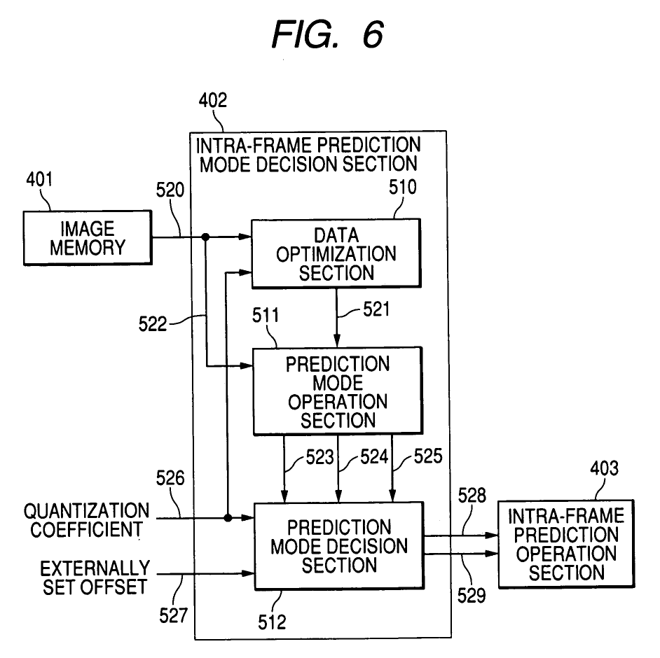

FIG. 6 is a block diagram showing details of the intra-frame prediction mode decision section 402 as shown in FIG. 5 according to an embodiment of the invention. Processing is done on the basis of 4 by 4 pixels in the intra-frame prediction mode decision section 402. Peripheral pixel data and 4-by-4 pixel target image data which are required for generation of virtual predicted image data are acquired from the image memory 401 shared with the motion prediction section 400. The acquired peripheral image data is target image data to be coded and there is tendency that as the quantization coefficient, which determines to what extent the lower bits of image data should be rounded (omitted) to decide the image data roughness, increases, deviation from the reference image data is larger. Therefore, peripheral image data 520 and quantization coefficient 526 are sent to a data optimization section 510 where the peripheral image data is optimized according to the value of the quantization coefficient, then the resulting data is sent to a prediction mode operation section 511. Optimization of peripheral image data is performed, for example, by quantization to round lower bits according to the value of the quantization coefficient.

In the prediction mode operation section 511, virtual predicted image data is generated from the above optimized peripheral image data 52 and target image data 522 in the target block to be coded, according to each mode. Using the generated virtual predicted image data, the sum of absolute differences (SAD) from 4-by-4 pixel target image data is calculated for each sub macroblock; then, the results of addition of SADs (equivalent to one macroblock) for each of the Intra 4×4, Intra 16×16 and Intra-chroma modes are sent through data lines 523, 524 and 525 to the prediction mode decision section 512.

Since whether to select either the Intra 4×4 mode or the Intra 16×16 mode largely depends on the quantization section in the next pipeline, an offset value is determined from the quantization coefficient 526 and an external offset value 527 for external compensation, and SAD 523 in the Intra 4×4 mode plus the determined offset value is compared with SAD 524 in the Intra 16×16 mode to determine 16 Intra 4×4 modes or one Intra 16×16 mode. The offset value is also used for peripheral image optimization. For the Intra-chroma mode as a color difference prediction mode, one with the smallest Intra-chroma SAD 525, is selected. The determined luminance prediction mode and color difference prediction mode are respectively sent through signal lines 528 and 529 to an intra-frame prediction operation section 403. Since the external offset value 527 can be externally set, flexibility is guaranteed in determining 16 Intra 4×4 modes or one Intra 16×16 mode and optimizing peripheral image data so that the image quality is enhanced.

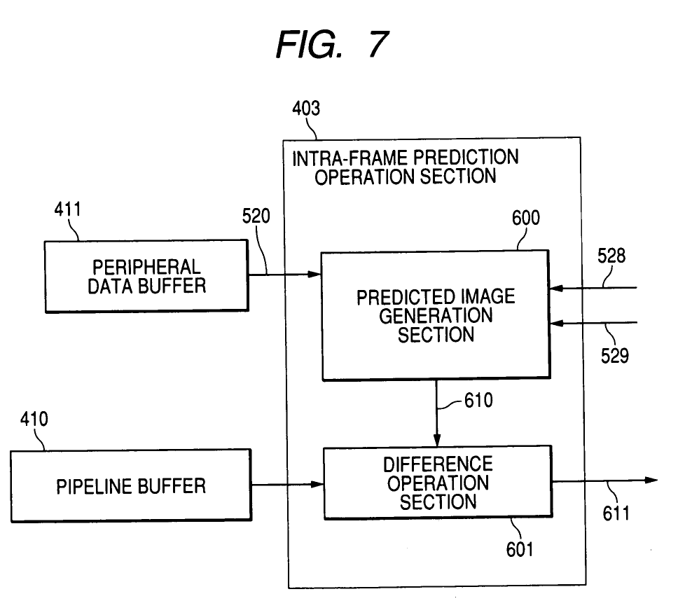

FIG. 7 is a block diagram showing details of the intra-frame prediction operation section 403 as shown in FIG. 5 according to an embodiment of the invention. In the intra-frame prediction operation section 403, a predicted image generation section 600 generates real predicted image data based on peripheral data from the peripheral data buffer 411 in accordance with the luminance component prediction mode 528 and the color difference prediction mode 529. A difference operation section 601 calculates the difference between target image data from the pipeline buffer 410 and the real predicted image data 610 generated by the predicted image generation section 600 to perform intra-frame prediction coding. The generated prediction coding data is sent through a data line 611 to the transformation section 404.

Referring to FIG. 5, the transformation section 404 performs transformation on the data which it has received and sends the resulting data to the quantization section 405. The quantization section performs quantization on the data which it has received and sends the resulting data to the inverse quantization section 406 and also stores it in the pipeline buffer 412. The inverse quantization section 406 performs inverse quantization on the data which it has received and sends the resulting data to the inverse transformation section 407. The inverse transformation section 407 performs inverse transformation and sends the resulting data to the intra-frame prediction inverse operation section 408. The intra-frame prediction inverse operation section 408 performs inverse operation and stores the resulting data in the pipeline buffer 410 and stores the peripheral data in the peripheral data buffer 411 to finish the pipeline operation.

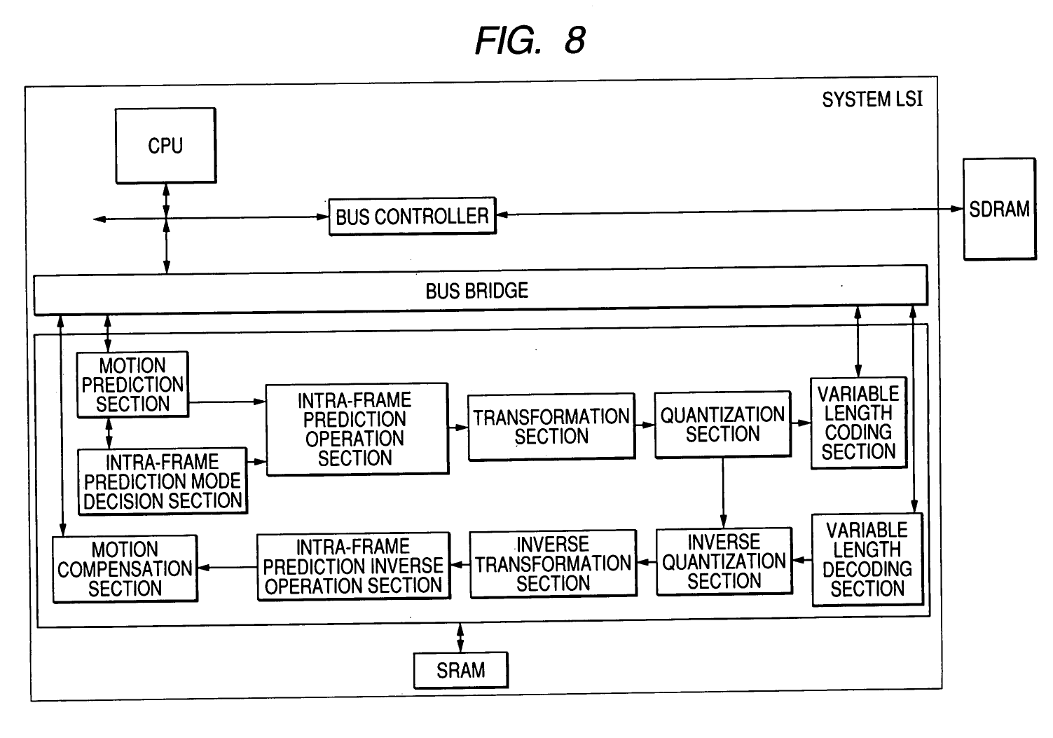

FIG. 8 is a block diagram showing a system LSI including an image coding unit according to an embodiment of the present invention. The system LSI in this embodiment is intended for mobile phones or similar devices, though not so limited. It includes: a central processing unit (CPU) designed for base band processing in mobile phones, a bus controller, a bus bridge, an image coding unit, and an SRAM (static random access memory). This SRAM constitutes the abovementioned pipeline buffer, peripheral data buffer and image memory. In addition to these, a DSP (digital signal processor), an ASIC (logical circuit) and a nonvolatile memory are mounted as necessary. An SDRAM, synchronous dynamic RAM, is used as an external large capacity image memory or the like.

The image coding unit is the same as the embodiment as shown in FIG. 5 except that a variable length coding section and a variable length decoding section are added. This means that if the variable length coding system is employed for advanced video coding, the variable length coding section and variable length decoding section are needed. An alternative coding system is the arithmetic coding system.

The invention made by the present inventors has been so far explained in reference to the above preferred embodiment thereof. However, the invention is not limited thereto and it is obvious that the invention may be embodied in other various ways without departing from the spirit and scope thereof. For example, the mode decision process and the process of generating predicted image data and reference data need not always be handled by pipeline processing. An alternative approach is that the mode decision process deals with information on one of the above nine modes during sub macroblock operations for generating predicted image data and reference data. More specifically, in the alternative approach, referring to FIG. 2, it is enough that before sub macroblock operation 1 for generating predicted image data and reference data as mentioned above, the mode decision process for the preceding sub macroblock 0 is finished through sub macroblock operations 00 to 80 for the nine intra-frame prediction modes. The present invention can be widely applied for image coding units and image coding methods.

What is claimed is:

1. An image coding unit which can perform coding process on a block-by-block basis, which is constituted by dividing a macroblock to be coded into a plurality of blocks, comprising:
a prediction mode decision part capable of performing a first operation in which plural types of first predicted image data are generated using image data to be coded in a block adjacent to a block concerned, and prediction mode decision information to select the most suitable first predicted image data of one type from among the plural types of first predicted image data is generated;
a prediction operation part capable of performing a second operation in which second predicted image data is generated using reference image data in an adjacent block according to the prediction mode decision information; and
a transformation part capable of performing a third operation in which difference between the second predicted image data and image data, which corresponds to the second predicted image data, and which should be coded, is coded.

2. The image coding unit according to claim 1, further comprising a signal processing circuit which decodes the image data coded by the coding process to generate reference image data for the block concerned.

3. The image coding unit according to claim 2, wherein when the second predicted image data for the block is generated by the prediction operation part, the prediction mode decision part generates prediction mode decision information for a next block to be processed by the prediction operation part.

4. The image coding unit according to claim 1,
wherein the macroblock comprises 16 pixels by 16 pixels; and
wherein the block is a sub macroblock which comprises 4 pixels by 4 pixels.

5. The image coding unit according to claim 1, wherein the image data to be coded is optimized according to a quantization coefficient value used for coding and the plural types of first predicted image data are generated.

6. The image coding unit according to claim 1, further comprising:
a prediction circuit having an image memory, a motion prediction section, and a motion compensation section,
wherein the prediction mode decision part acquires the image data to be coded, from the image memory.

7. The image coding unit according to claim 6, wherein the prediction circuit and the prediction mode decision part constitute a first stage in pipeline operation, and the transformation part except the prediction mode decision part constitutes a second stage in pipeline operation.

8. The image coding unit according to claim 1, wherein the image coding unit is mounted on a system LSI including the image memory and a central processing unit.

9. The image coding unit according to claim 1, wherein the first, second and third operations are intended to perform the coding process using image data for one frame.

10. The image coding unit according to claim 5, wherein the prediction mode decision part optimizes data according to the quantization coefficient value and a compensation value given externally, and selects the most suitable first predicted image data of one type.

11. An image coding method which can perform coding process, on a block-by-block basis, which is constituted by dividing a macroblock to be coded into a plurality of blocks, comprising:
a first step which generates plural types of first predicted image data using image data to be coded in a block adjacent to a block concerned, and generates and stores prediction mode decision information for selecting the most suitable first predicted image data of one type from among the plural types of first predicted image data; and
a second step which performs prediction operation to generate second predicted image data using reference image data in an adjacent block according to the stored prediction mode decision information, codes difference between the second predicted image data and image data, which corresponds to the second predicted image data and which should be coded, and which decodes the difference to generate reference image data for the block.

12. The image coding method according to claim 11, wherein second predicted image data for the block to be processed by the prediction operation part is generated at the first step thereby to perform the coding process and generate image data, prediction mode decision information for a next block to be processed by the intra-frame prediction operation part is generated at the second step in parallel with to perform the coding process and generate the image data.

13. The image coding method according to claim 12,
wherein the macroblock comprises 16 pixels by 16 pixels; and
wherein the block is a sub macroblock which comprises 4 pixels by 4 pixels.

14. The image coding method according to claim 11, wherein the first and second steps are intended to perform the coding process using image data for one frame.
